(19) United States
(12) Patent Application Publication
(10) Pub. No.: US 2005/0024862 A1
(43) Pub. Date: Feb. 3, 2005

(54) Portable light with removable, interchangeable signal covers

(76) Inventor: William R. Laux, Belvidere, NJ (US)

Correspondence Address: Kenneth P. Glynn, Esq.;Glynn & Associates, P.C., 24 Mine Street, Flemington, NJ, 08822, US

(21) Appl. No.: 10/631,090

(22) Filed: Jul. 30, 2003

(51) Int. Cl. F21L 4/00; F21V 1/12; G09F 13/04

(52) U.S. Cl. 362/186; 362/311; 362/360; 40/575

(57) ABSTRACT

The present invention is a portable light for presenting an illuminated illustration such as a warning signal, or a hailing signal or a location signal. These could be for the local pizza delivery man, a taxi, a doctor, or a finder light for a new visitor. The present invention portable light includes a.) a portable light fixture, including a housing, at least one bulb, a power supply, an electrical connection between the power supply and the at least one bulb, and an on/off switch located within the electrical connection; b.) a first cover connected to the housing and covering the bulb(s). The first cover is at least translucent, and could be transparent, wherein at least one of the housing and the first cover includes attachment means for removably attaching a second cover thereto and at least partially atop at least part of the first cover; c.) a second cover having a distinguishable illustration thereon removably attached to at least one of the housing and the first cover, at least partially atop at least part of the first cover. The distinguishable illustration may be any recognizable informative representation. It may be selected from one or more letters, words, logo, stylized character and one or more numbers, or combinations thereof The housing may include attachment means for attaching said second cover thereto, or the first cover may include attachment means for attaching said second cover thereto, or both.

### BACKGROUND OF THE INVENTION

1. Field of the Invention

The present invention is directed to helping visitors to a location at night to easily find the desired location. Hence, a portable light may be put out on a wall (or other vertical hanging member) to signal a need. The portable light has a second cover that includes the illustration.

2. Information Disclosure Statement

The following patents relate to illuminated signage and their fixtures:

U.S. Pat. No. 4,488,368 describes a sign structure shown for universal mounting on generally vertically extending support means. The body of the sign is simple to manufacture and is formed of extruded aluminum bar stock in a manner to have a rigidifying mounting flange being also provided for attaching the sign to the support means. The sign is fully sealed against the elements and may be illuminated by suitable means preferably positioned within the inside of the body of the sign.

U.S. Pat. No. 5,176,239 describes an escalator or travelator provided with a plurality of advertising signs on the riser or step of the escalator or travelator. The sign is provided with a transparent cover which is positioned on the step so as not to interfere with the relative movement of adjacent steps on the escalator/travelator or the cyclic movement of the escalator/travelator itself.

U.S. Pat. No. 5,517,779 describes a sign face frame structure for universal mounting on generally a vertically extending support. The body of the sign face frame is simple to manufacture and is formed of extruded aluminum bar stock in a manner to have a rigid mounting flange or leg surrounding the sides and bottom of the perimeter of the face frame, the flange being also provided for attaching the sign to the support. The sign face frame includes a semi-circular member to interfit with a receiver of various mounting designs. This semi-circular receiver may be incorporated into a sign base frame embodiment as an appendage or it may be provided as an independent part to be attached to a sign frame or building for the installation purposes of a sign face. The semi-circular receiver is designed for supporting the full weight of the face frame during installation until such time that sides and bottom mounting flanges or legs are attached or mechanically fastened to add relief to the weight bearing or attachment bond of the assembly. The assembled sign is fully sealed against the elements and may be illuminated by suitable devices preferably positioned within the inside of the body of the sign.

U.S. Pat. No. 6,050,013 describes an exit sign, where a cover member for an emergency exit sign has a pair of hook members on its bottom wall and a pair of resilient spring finger members on its top wall. The hook members are dimensionally sized and appropriately positioned to engage catch members on an exit sign housing while the spring finger members resiliently snap fit within spaced apart apertures in the top wall of the exit sign housing thereby retaining the cover member in its closed position. A pair of flexible straps secure the cover member to the exit sign housing to keep them in assembly when the cover member is in its open position.

Notwithstanding the prior art, the present invention is neither taught nor rendered obvious thereby.

### SUMMARY OF THE INVENTION

The present invention is a portable light for presenting an illuminated illustration such as a warning signal, or a hailing signal or a location signal. These could be for the local pizza delivery man, a taxi, a doctor, or a finder light for a new visitor.

The present invention portable light includes a.) a portable light fixture, including a housing, at least one bulb, a power supply, an electrical connection between the power supply and the at least one bulb, and an on/off switch located within the electrical connection; b.) a first cover connected to the housing and covering the bulb(s). The first cover is at least translucent, and could be transparent, wherein at least one of the housing and the first cover includes attachment means for removably attaching a second cover thereto and at least partially atop at least part of the first cover; c.) a second cover having a distinguishable illustration thereon removably attached to at least one of the housing and the first cover, at least partially atop at least part of the first cover. The distinguishable illustration may be any recognizable informative representation. It may be selected from one or more letters, words, logos, stylized characters and one or more numbers, or combinations thereof. The housing may include attachment means for attaching said second cover thereto, or the first cover may include attachment means for attaching said second cover thereto, or both.

In some preferred embodiments, the attachment means is a linear track and the second cover is a linear strip adapted to slide into and out of the track. The attachment means may be any mechanism that will connect the second cover to the first cover and/or the housing, and could be on any one, or any two or all of the housing, the first cover and the second cover.

In some embodiments, the second cover is substantially transparent, the first cover is at least translucent of a first color and the distinguishable illustration is translucent and of a second color, different from the first cover. In other embodiments, varying transparency/translucency and/or colors or shades, may be used to distinguish the illustration from the background (first and second covers).

The present invention portable light first cover may be a circular cover, an oval cover, a square, hexagonal, rectangular or octagonal cover, or any other desired shape.

The present invention portable light power source may be at least one battery, or equivalent power source, such as a storage element, a solar cell, or the like.

In some preferred embodiments, the housing is adapted for attachment to a wall (or fixture on a wall). Thus, a wall attachment means may be connected to the housing, wherein a user may attach the second cover to the portable light with a distinguishable illustration, and attach it to an outside wall at night to signal a need.

### BRIEF DESCRIPTION OF THE DRAWINGS

The present invention should be more fully understood when the specification herein is taken in conjunction with the drawings appended hereto wherein:

FIGS. 1 and 2 show front and side views of a present invention portable lamp with the covers removed;

FIGS. 3 and 4 show the same present invention portable lamp as above, but with the first cover attached;

FIGS. 5 and 6 show the same present invention portable lamp as above, but with both the first cover and the second cover attached;

FIGS. 7 and 8 show front views of alternative embodiments of the present invention portable lamps;

FIGS. 9 and 10 illustrate a front and side view of yet another present invention portable lamp with a slide-out second cover;

FIG. 11 shows another type of second cover used in a present invention portable lamp; and,

FIG. 12 shows yet another type of second cover used in a present invention portable lamp.

### DETAILED DESCRIPTION OF THE PRESENT INVENTION

FIGS. 1 and 2 show front and side views of a present invention portable lamp 100 with the covers removed. There is a cylindrical housing 3, with a back 35, and attachment tabs 5 and 7, as shown. There is also an on/off switch 9 that intervenes in a connection between batteries 21 and 23, and bulb 13 of socket 15, as exemplified by wires 17 and 19. These aspects are known for portable lighting, and any functional arrangement of wiring or printed circuitry may be used to connect the power source to the light bulb(s). Likewise, any on/off switch may be used, e.g., the type wherein the cover is depressed to cycle on and off could be used as an alternative to the push button or slider switch.

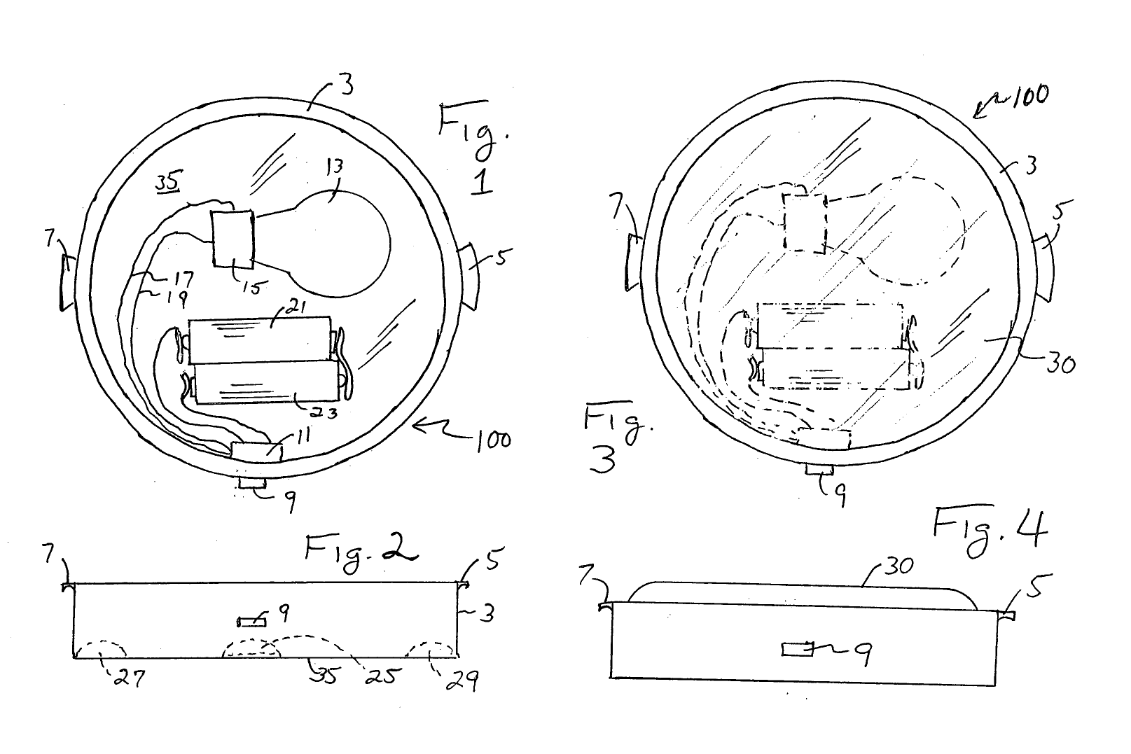

In FIGS. 3 and 4, the identical components are identically numbered, as above. In these Figures, first cover 30 has been snapped into the housing 3, and this type of removable cover for battery and/or bulb replacement is well known.

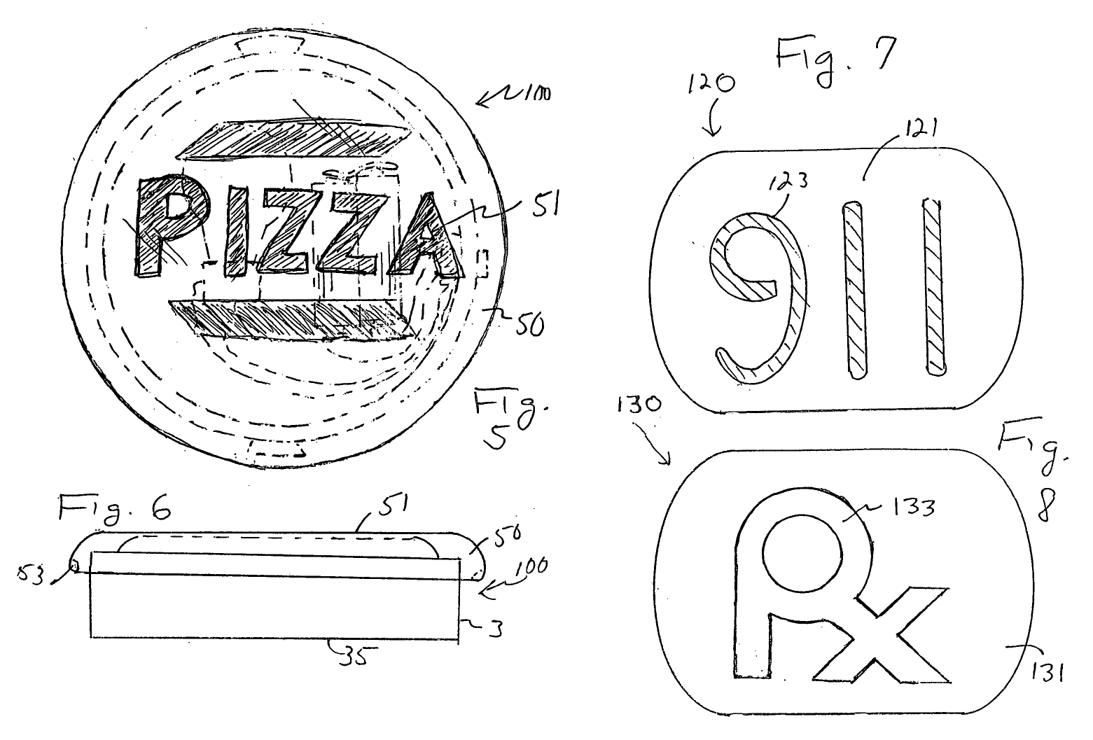

In FIGS. 5 and 6, second cover 51 is attached by being fitted at its rim 53 over attachment tabs 5 and 7. These tabs could be holes with snap ins on the second cover 51, or any other attachment arrangement that permits removal and reattachment. This permits access for battery and/or bulb replacement, and allows for interchangeability of different top (second) covers. Here, cover 51 has a notice for the pizza man so that he may easily find the correct house or apartment for pizza delivery. The word “PIZZA” 53 could be any useful message to a stranger or other person needing to locate a place, home, apartment, office, boat, vehicle or other locale at night.

FIGS. 7 and 8 show front views of alternative embodiments of the present invention portable lamps 120 and 130, respectively. These are shaped like pillows (linear top and bottom edges and rounded ends), but could be of any shape desired. Second covers 121 and 131 are identical, and are placed on light with first covers as in the preceding examples. However, cover 121 of FIG. 7 shows a police locator signal, as “911”, while cover 131 of FIG. 8 has an “RX” to aid the deliverer of pharmacy goods to the correct location. These would clearly be interchangeable with one another.

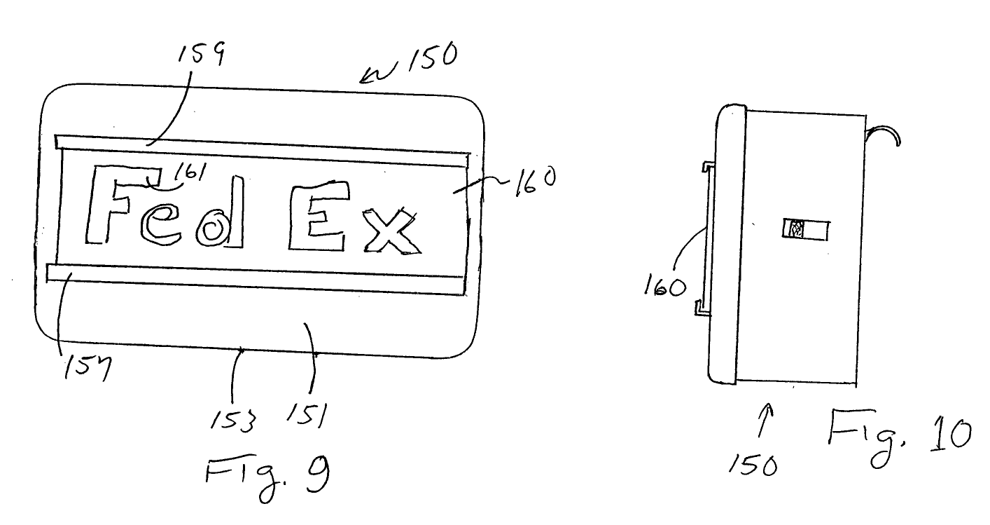

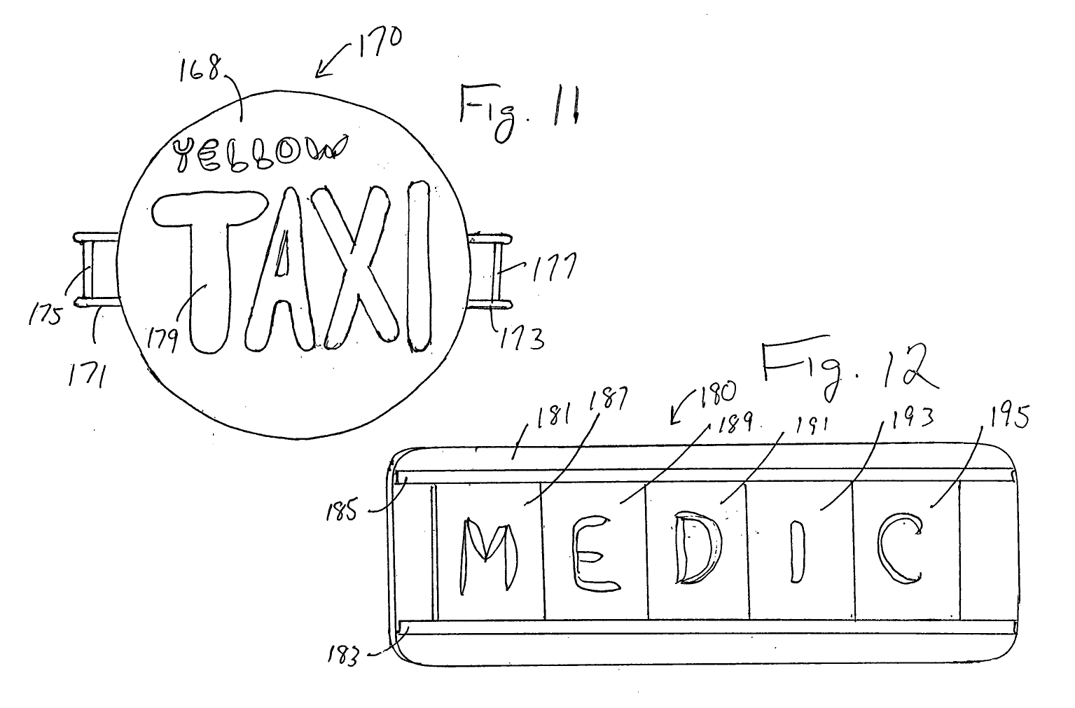

FIGS. 9 and 10 illustrate a front and side view of yet another present invention portable lamp 150 with a first cover 151, attached to a base housing 153. First cover 151 has second cover attachment means, in this case, a set of rails 157 and 159, for insertion and removal of slide-out second cover 160, as shown. In this case, the Federal Express 161 logo is displayed to assist a FedEx guy to find an evening pick up.

FIG. 11 shows another type of second cover 170, used in a present invention portable lamp, wherein second cover clear plastic area dome 168 displays a “TAXI” signal 179, and includes snap on fasteners 173 and 177 with catch bars 175 and 177, respectively, for attachment to a first cover and/or housing.

FIG. 12 shows yet another type of second cover 180 used in a present invention portable lamp. First cover 181 has second cover slider tracks 183 and 185, for insertion and removal of various letters with clear backs to create whatever message desired. Hence, letters 187, 189, 191, 193, 195 are inserted to create the word “MEDIC” to assist a doctor, medic, nurse or other person to locate someone or something at night, e.g., a home, a boat at a pier, a car in a mall lot, or other place in need of medical help.

Obviously, numerous modifications and variations of the present invention are possible in light of the above teachings. It is therefore understood that within the scope of the appended claims, the invention may be practiced otherwise than as specifically described herein.

1. A portable light for presenting an illuminated illustration, which comprises:
a.) a portable light fixture, including a housing, at least one bulb, a power supply, an electrical connection between said power supply and said at least one bulb, and an on/off switch located within said electrical connection;
b.) a first cover connected to said housing and covering said at least one bulb, said first cover being at least translucent, wherein at least one of said housing and said first cover includes attachment means for removably attaching a second cover thereto and at least partially atop at least part of said first cover; and
c.) a second cover having a distinguishable illustration thereon removably attached to at least one of said housing and said first cover, at least partially atop at least part of said first cover.

2. The portable light of claim 1 wherein said housing includes attachment means for attaching said second cover thereto.

3. The portable light of claim 1 wherein said first cover includes attachment means for attaching said second cover thereto.

4. The portable light of claim 3 wherein said attachment means is a linear track and said second cover is a linear strip adapted to slide into and out of said track.

5. The portable light of claim 1 wherein said distinguishable illustration is selected from one or more words, a logo, a stylized character and one or more numbers.

6. The portable light of claim 5 wherein said second cover is substantially transparent, said first cover is at least translucent of a first color and said distinguishable illustration is translucent and of a second color, different from said first cover.

7. The portable light of claim 1 wherein said first cover is a circular cover.

8. The portable light of claim 2 wherein said first cover is a circular cover.

9. The portable light of claim 3 wherein said first cover is a circular cover.

10. The portable light of claim 1 wherein said power source is at least one battery.

11. A portable light for presenting an illuminated illustration, which comprises:
a.) a portable light fixture, including a housing, at least one bulb, a power supply, an electrical connection between said power supply and said at least one bulb, and an on/off switch located within said electrical connection;
b.) a first cover connected to said housing and covering said at least one bulb, said first cover being at least translucent, wherein at least one of said housing and said first cover includes attachment means for removably attaching a second cover thereto and at least partially atop at least part of said first cover;
c.) a second cover having a distinguishable illustration thereon removably attached to at least one of said housing and said first cover, at least partially atop at least part of said first cover; and
d.) wall attachment means connected to said housing,
wherein a user may attach said second cover to said portable light with a distinguishable illustration, and attach it to an outside wall at night to signal a need.

12. The portable light of claim 10 wherein said housing includes attachment means for attaching said second cover thereto.

13. The portable light of claim 10 wherein said first cover includes attachment means for attaching said second cover thereto.

14. The portable light of claim 13 wherein said attachment means is a linear track and said second cover is a linear strip adapted to slide into and out of said track.

15. The portable light of claim 10 wherein said distinguishable illustration is selected from one or more words, a logo, a stylized character and one or more numbers.

16. The portable light of claim 15 wherein said second cover is substantially transparent, said first cover is at least translucent of a first color and said distinguishable illustration is translucent and of a second color, different from said first cover.

17. The portable light of claim 10 wherein said first cover is a circular cover.

18. The portable light of claim 12 wherein said first cover is a circular cover.

19. The portable light of claim 13 wherein said first cover is a circular cover.

20. The portable light of claim 11 wherein said power source is at least one battery.
